(19) United States
(12) Patent Application Publication
(10) Pub. No.: US 2004/0194562 A1
(43) Pub. Date: Oct. 7, 2004

(54) Sample probe guide support

(75) Inventors: Adam H. Brockman, Salem, CT (US); Donald J. Smith, Salem, CT (US); J. Fred Banks, East Lyme, CT (US)

Correspondence Address: PFIZER INC., PATENT DEPARTMENT, MS8260-1611, EASTERN POINT ROAD, GROTON, CT, 06340, US

(73) Assignee: Pfizer Inc.

(21) Appl. No.: 10/755,063

(22) Filed: Jan. 8, 2004

Related U.S. Application Data
(60) Provisional application No. 60/513,552, filed on Oct. 24, 2003.
(60) Provisional application No. 60/439,685, filed on Jan. 13, 2003.

(51) Int. Cl. G01N 35/10

(52) U.S. Cl. 73/864.24; 73/864.22

(57) ABSTRACT

A liquid sample handler guide support has a support plate fixedly mounted to the liquid sample handler sample probe support head, which support head is movable between sample aspirating positions, and which support plate has a hole, and a plastic cylindrical guide having a hole is mounted in the plate hole. The sample probe is slidably disposed in the guide during the liquid sample handler operations. A rinse cup is reciprocally movable to a probe rinse position below the guide for insertion of the probe tip for rinsing.

### CROSS REFERENCE TO RELATED APPLICATION

This application claims priority of U.S. Provisional Application No. 60/513,552 filed Oct. 24, 2003, which claims priority of U.S. Provisional Application No. 60/439,685 filed Jan. 13, 2003

### BACKGROUND OF THE INVENTION

1. Field of the Invention

This invention relates to liquid sample handlers and chemical analyzers. This invention specifically relates to a liquid sample probe guide support for a chemical analyzer or liquid sample handler.

2. Discussion of the Prior Art

Liquid sample probes or aspirating needles are generally used in automated chemical analyzers and liquid sample handlers. The liquid sample probes are generally used to transfer an aliquot liquid sample between an aspirating station, wherein sample material is drawn into the probe, and a dispensing station, wherein the aspirated sample is dispensed into a receptacle for analysis or further manipulation, such as chemical reactions. The probe, after dispensing the aliquot of liquid sample, is transferred to another aspirating station to receive another aliquot of liquid sample. An exemplary prior-art liquid sample handler is the 215 Liquid Handler/injector from Gilson, Inc.

After dispensing the liquid sample, the probe may retain residual sample liquid on both the inside and outside of the probe tip. This residual liquid on or in the probe tip is a source of contamination in subsequent analyses.

The art provided various means for washing or cleaning the probe tip after dispensing the sample liquid and before aspirating another aliquot of sample liquid. Traditionally, the art provided a discrete sample probe wash station. The sample probe was transferred from the dispensing station to the wash station and then in turn to the aspirating station. Probe wash stations are shown and described in Sindermann, U.S. Pat. No. 3,964,526, Suzuke et al., U.S. Pat. No. 4,318,885, Ohlin, U.S. Pat. No. 3,552,212 and Mody, U.S. Pat. No. 4,323,537. The wash stations were generally less than successful in that the liquid sample handler or chemical analyzer efficiency was substantially reduced by the additional time required to transfer the sample probe to and from the wash station. The resultant probe washing was also often inadequate insofar as minute residual amounts of liquid often remained on and/or in the probe tip.

Barber et al., U.S. Pat. No. 5,408,891 addressed certain aspects of the wash station deficiencies by providing a wash collar that utilized pressurized water and subsequent vacuum for improved cleaning. Fose et al., U.S. Pat. No. 5,827,744, provided an improvement to Barber et al., by the inclusion of a washing chamber. In the Fose et al. construction, the probe was transferred to and into the remotely disposed washing chamber, and purging and cleaning solutions were respectively pumped through and around the probe. A partial vacuum airflow removed the purging and cleaning solutions.

The aforesaid prior art provided certain improvements in probe washing and cleaning. However, the automated chemical analyzer operations, by virtue of the time required to transfer the probe to and from the wash station or washing chamber, are significantly slower than the art desired.

One attempt to improve the efficiency of chemical analyzers is to mount a wash or rinse cup to a vertically depending probe. The aspirating needle or probe and wash cup are respectively mounted to a movable support head, and the probe is washed in the cup during transfer between aspirating and dispensing stations. This prior art wash cup and probe mounting assembly is disclosed in Maldarelli et al. U.S. Pat. No. 4,140,018 and Howell, U.S. Pat. No. 4,820,997. Howell discloses an aspirating needle cleaning assembly wherein a pivotally articulating wash cup is mounted to a vertically depending probe to provide an assembly for washing during probe transfer between stations. Maldarelli et al. likewise discloses a wash cup which is pivotally mounted to a support head and mounted to a vertically depending probe to provide an assembly wherein the probe is washed during transfer between stations. Maldarelli et al. and Howell disclose wash cup to probe mounting on a movable probe support head with cup probe washing during movement or transfer of the support head. In Maldarelli et al and Howell, the vertically depending probe and pivotally articulating wash cup have to be accurately aligned and positioned for correct assembly. The art desired a construction that avoided such alignment and positioning impediments, to improve the operation and increase the speed and efficiency of the automated chemical analyzer or liquid sample handler.

### SUMMARY OF THE INVENTION

A cylindrical guide with a through hole is mounted on a plate having a coaxial aperture or through hole, and the probe is slidably disposed in the guide. The probe slidably reciprocates in the guide and is movable together with the guide and support plate with movement of the liquid handler probe support head. The probe remains slidably disposed in the guide throughout all probe movements and liquid sample handler movements during liquid sample handling and in probe tip washing. A wash or rinse cup is mounted on a plate which is reversibly horizontally movable with respect to the liquid handler support arm. When the rinse cup is horizontally moved to a predetermined position in alignment with and below the probe, the probe is slidably downwardly moved through the probe guide hole and inserted into the rinse cup. A cleaning or rinsing fluid is passed through the sample probe, and a partial vacuum is applied to remove residual cleaning fluid. The cleaned probe tip is retracted from the cup, but remains slidably disposed in the guide. The rinse cup is reversibly horizontally moved to its initial position. With the rinse cup returned to its original position, the probe tip is then free to be fully extended downwardly. The fully extended probe tip is inserted into a reagent receptacle. A liquid sample is aspirated into the sample probe and passed through a multi-port injector valve fixedly mounted to the support arm. The multi-port injector valve dispenses a predetermined volume of the aspirated liquid sample through an end of the probe remotely disposed from the probe tip aspiration end. The multi-port injector valve may also be adapted to dispense a predetermined volume of the aspirated liquid sample from the probe tip aspiration end. The sample probe tip is retracted from the reagent receptacle into the guide. The cup is then repositioned below the guide for rinsing, as previously described. Rinsing fluid is passed through the sample probe into the bottom of the wash or rinse cup. A vacuum line is attached to the bottom of the cup to remove residual liquid. Rinsing occurs immediately after aspiration, as the liquid sample is being dispensed from the valve through the flexible probe to the desired receptacle for analysis or reaction. After probe tip rinsing, the probe support arm moves the probe, rinse cup assembly and dispensing valve on X-Y coordinates to a second position for aspiration of the next liquid sample aliquot.

The liquid sample probe is at all times operably, slidably disposed in the guide. The liquid sample probe is disposed in the guide when the probe is extended and retracted in and to the following positions: (i) a retracted probe position so as to clear the slide plate, with wash cup returned to initial position, (ii) an intermediate downwardly extended position prior to insertion into the rinse cup for probe washing, (iii) a fully extended position for sample aspiration, and (iv) a fully retracted position with the probe tip end remaining in the guide. The dispensing of the liquid sample occurs with actuation of the multi-port dispensing valve immediately after aspirating, and rinsing occurs immediately thereafter. The probe is not moved to a dispensing station or to a rinsing station.

### BRIEF DESCRIPTION OF THE DRAWINGS

FIG. 1 is a perspective and partial schematic view of the liquid sample handler and sample probe guide support;

FIG. 2 is a side elevational partial sectional view of the probe rinsing assembly of FIG. 1 in the rinse position;

FIG. 3 is a side elevational partial sectional view of the probe rinsing assembly of FIG. 1 in the probe fully retracted and support arm transfer position;

FIG. 4 is a side elevational partial sectional view of the probe rinsing assembly of FIG. 1 in the sample aspirating station; and

FIG. 5 is an enlarged top perspective view of the probe guide support.

### DESCRIPTION OF THE PREFERRED EMBODIMENTS

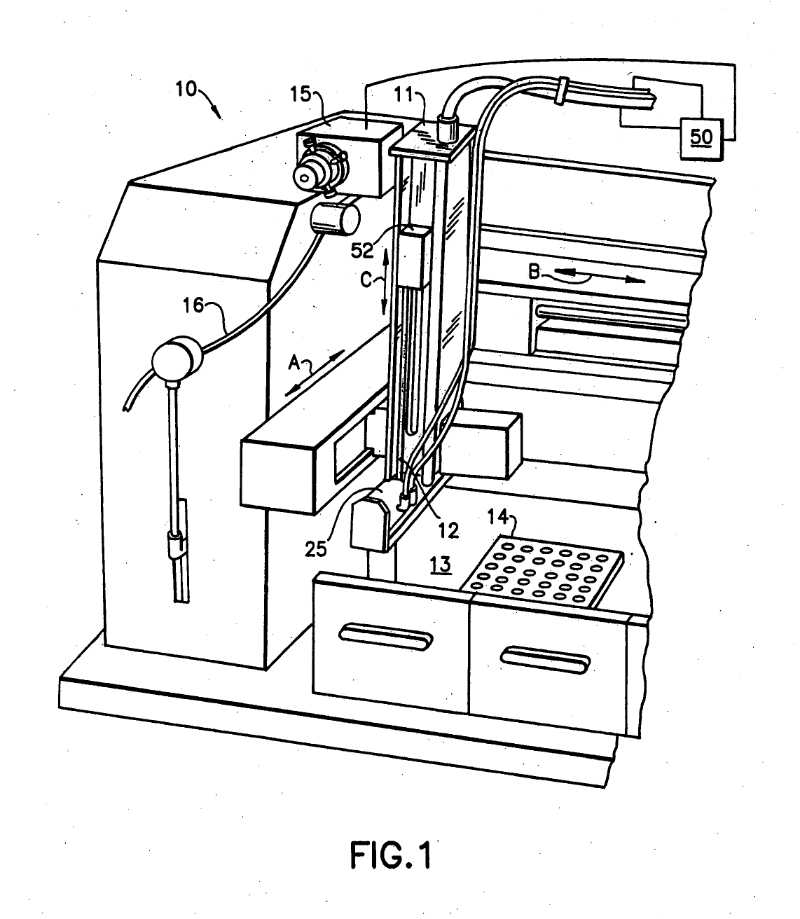

Referring to the FIGS., there is shown automated chemical analyzer or liquid sample handler 10. Liquid sample handler 10 includes a probe support head 11, a thin flexible aspirating needle or probe 12 and a table 13 having a plurality of liquid reagent cups 14 (typical). The support head 11 is programmably movable on X-Y axes designated by arrows A and B in FIG. 1. This probe support head 11 X-Y translation or movement is well known in the art, as exemplified in the aforementioned Maldarelli et al. patent.

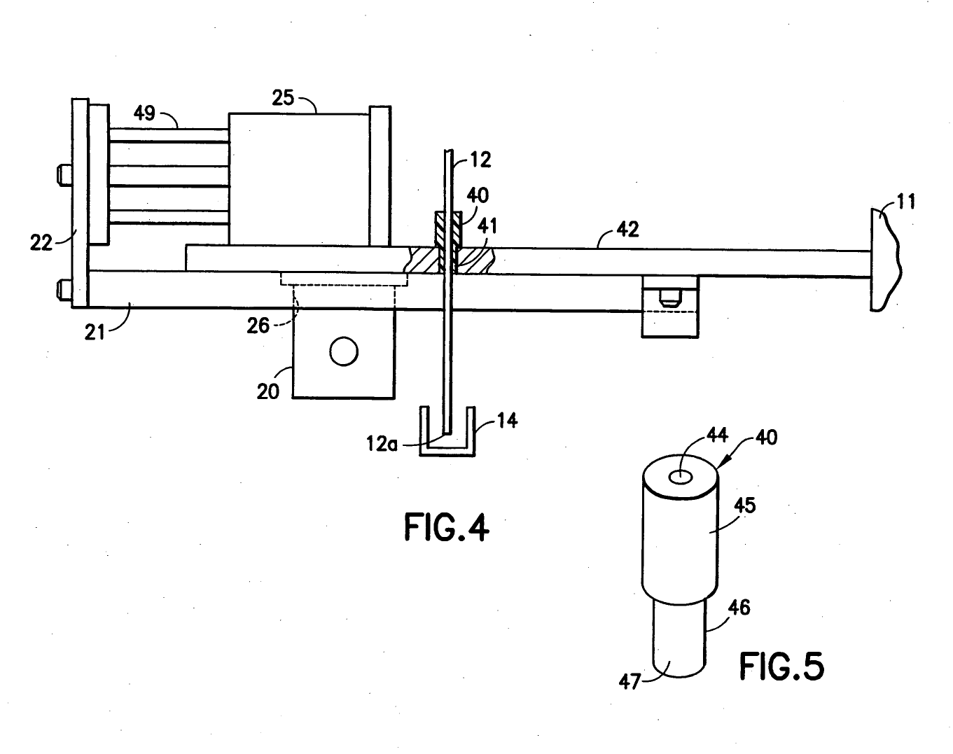

Probe 12 is reversibly downwardly extendable by means well known in the art, which reciprocal motion is designated by the double-headed arrow C in FIG. 1. Probe 12, when fully downwardly extended, causes probe tip 12a to be inserted into a reagent cup 14 for aspiration of an aliquot of liquid reagent sample, as best shown in FIGS. 1 and 4. Such aspiration technique is well known in the art.

In a first preferred embodiment, immediately after aspiration, a predetermined amount of liquid reagent is passed through control valve 15 and in turn through dispensing tube end 16 into a reaction cup or analyzer receptacle (not shown). It has been found pursuant to the present invention that control valve 15 is preferably, but not limited to, a multi-port injection valve, such as a 2-position, 6-port sample injection valve, Model No. ETC6010, manufactured by Valco Instruments, Inc., Houston, Tex. In this manner of construction, there is one directional movement of the liquid sample through the probe. This one directional movement of the sample from the probe is known in the art as exemplified in U.S. Pat. No. 4,836,036 to Baldwyn. This one direction reagent movement is in contradistinction to the probe end or tip serving to both aspirate and dispense an aliquot liquid reagent, as disclosed in the afore-discussed Maldarelli et al. and Howell patents.

In a second preferred embodiment, the liquid sample handler 10 and probe 12 may be adapted to both aspirate and dispense an aliquot liquid reagent directly from probe 12. Such a “push-pull” capability is particular useful for sample derivatization (e.g., making a fluorescent species) and protein precipitation.

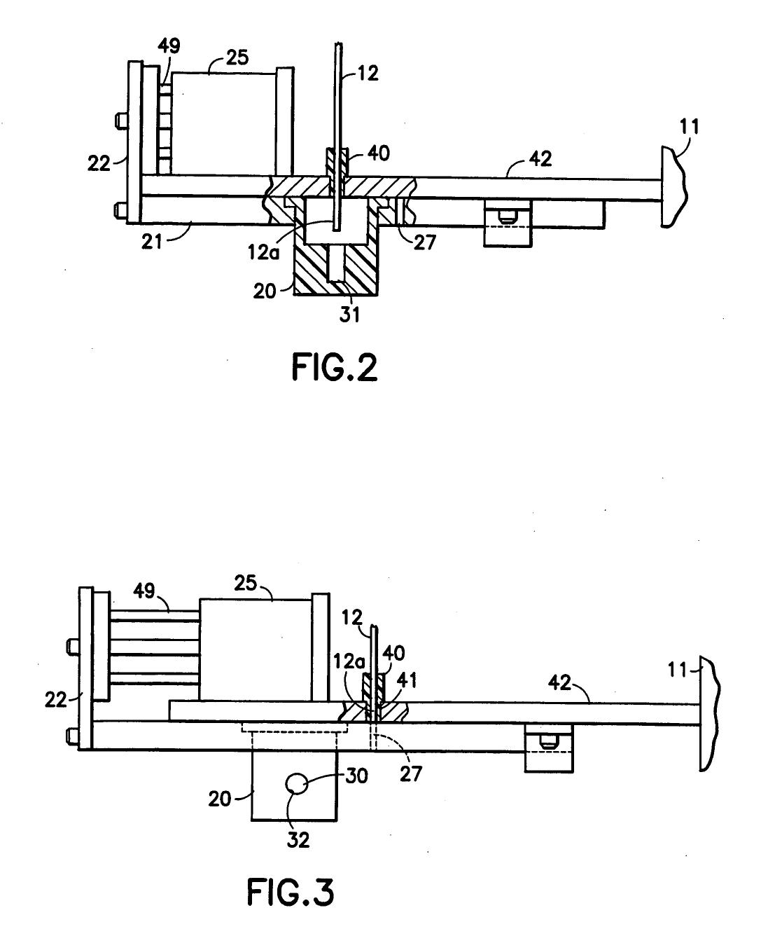

Pursuant to the present invention, wash or rinse cup 20 is fixedly mounted in hole 26 formed in horizontally disposed shuttle plate 21. Shuttle plate 21 is connected to vertically disposed support plate 22. A horizontally disposed cylinder 25 has extendably retractable rods 49. Cylinder 25 is fixedly mounted to horizontally disposed support plate 42, whereby with actuation of the cylinder 25, rods 49 are retracted so as to horizontally move rinse cup 20 to be operably aligned and disposed below probe 12 (FIG. 2). After rinse cup alignment, probe tip 12a is a fully downwardly extended to be inserted into rinse cup 20 for probe rinsing. This probe tip rinse position as best shown in FIG. 2. Shuttle plate 21 is formed with a downwardly disposed through hole 27, for purposes hereinafter appearing.

Rinse cup 20 is provided with rinsing fluid and vacuum lines (not shown) for rinsing probe tip 12a. A drain hole 30 extends downwardly at 31 and horizontally at 32 to remove residual fluid by partial vacuum means (not shown). The construction and use of a rinsing fluid and partial vacuum means to rinse a probe tip is well known in the art.

In the present invention, a probe guide 40 is press fitted into an aperture or hole 41 formed in support of plate 42. Support plate 42 is fixedly mounted to probe support head 11. Probe guide 40 is formed with through-hole 44 sized to slidably receive probe 12. In other words, the plate aperture 41 and the guide through-hole 44 are in alignment, so that the probe 12 may be slidably and simultaneously disposed in the guide 40 and the plate 42.

In this manner of construction, when probe 12 is reversibly extended, as indicated by arrow C (FIG. 1), the probe 12 is continuously guided and supported by guide 40. Probe 12 is disposed in guide 40 at all times. Probe 12 is formed of thin flexible plastic or metal tubing, and as such may be readily flexed, deflected or damaged in movement. Guide 40 prevents undesired flexing, breakage or misalignment of probe 12.

Referring specifically to FIG. 5, while guide 40 may have any suitable shape and size, it preferably has a cylindrical upper body 45 and a contiguous lower cylindrical body 46. Central through-hole 44 extends through body 45 and body 46. Lower cylindrical body 46 has an outer cylindrical periphery 47 which is slidably press fitted into support plate hole 41. Guide 40 is preferably an injection molded or machined, hard, low coefficient of friction plastic, such as DELRIN®. Shuttle plate 21 is formed with through hole 27 which has a diameter slighter larger than that of guide through hole 44.

In this manner of construction, cylinder 25 is moved by extendible rods 49, and consequently shuttle plate 21 is moved laterally or horizontally so that shuttle plate hole 27 is aligned and coaxially disposed below guide hole 44 (FIG. 3). Programmable controller 50 actuates cylinder 25 to perform this function. When shuttle plate 21 is moved into the position of FIG. 3, controller 50 signals probe drive motor 52 to fully extend probe 12 into a predetermined position in reagent cup 14 (FIG. 4). It is an important aspect of the present invention that the guide and guide support plate provide aligned guiding probe support as the flexible probe is fully extended to the aspirating position (FIG. 4). This probe guide support feature assures proper probe alignment and prevents undue flexure or breakage of the thin-wall probe.

Once the probe tip is fully extended and inserted into the reagent cup 14, the controller 50 then signals vacuum aspiration (not shown) of an aliquot liquid sample or reagent. The controller 50 also actuates valve 15 to dispense a predetermined aliquot liquid sample for e.g. analysis, such as chromatographic analysis or further chemical reactions.

After aspiration, controller 50 actuates retraction of the probe 12 to a pre-rinse position as shown in FIG. 3. In the pre-rinse, post-aspiration probe position (FIG. 3), the controller 50 actuates cylinder 25 to retract extendable rods 49 to move rinse cup 20 into the position shown in FIG. 2. Probe 12 is then extended to a probe tip rinse position, as shown in FIG. 2. The probe tip is then rinsed in cup 20 by rinsing fluid. Residual rinsing fluid is drained through the rinse cup drain hole and outlet, by applying a partial vacuum, through means well known in the art.

Probe 12, whether in the fully extended aspiration position (FIG. 4), the fully retracted pre-rinse position (FIG. 3), or the probe tip rinse position (FIG. 2), is always disposed within plastic probe guide 40.

After rinsing, controller 50 causes retraction of the probe tip to the position as shown in FIG. 3. The controller then actuates the probe support head 11 to move the probe along the X and Y coordinates (arrows A and B in FIG. 1) to the next aspirating position.

As is known in the art, a liquid sample handler may be adapted to aspirated two or more aliquots into a probe, which aliquots may be separated by air gaps, immiscible fluids, solvents, or any other suitable substance. In the present invention, probe 12 may be inserted into a first reagent cup from which a first aliquot is aspirated, then lifted so that air may be aspirated into probe 12, followed by probe 12 being inserted into a second reagent cup from which a second aliquot is aspirated. Probe 12 may be washed before being inserted into the second reagent cup.

While the present invention has been described with reference to the details of the embodiment of the invention shown in the drawing, these details are not intended to limit the scope of the invention as claimed in the appended claims.

What is claimed is:

1. A liquid sample handler probe guide support comprising:
a plate, and means for mounting said plate to a liquid sample handler sample probe support head; and
a guide formed with a through-hole, said guide hole being sized to slidably receive a sample probe, and means for supportably mounting said guide on said plate;
whereby the sample probe is slidably disposed in the guide.

2. The probe guide support of claim 1, wherein the guide comprises a vertically disposed cylinder.

3. The probe guide support of claim 1, said plate being formed with an aperture, said plate aperture and said guide through-hole being in alignment so that the probe may be slidably and simultaneously disposed in the guide and the plate.

4. The probe guide support of claim 3, said guide and plate being cooperatively formed for press fitting the guide into the plate aperture.

5. In combination:
a liquid sample probe;
a liquid sample handler having a movable support head, said probe being operably mounted on said support head so as to be reciprocally movable in relation to said support head; and
a probe guide support assembly comprising a plate, and means for mounting said plate to the support head, and a guide being formed with a through-hole sized to slidably receive the probe, and means for mounting said guide to said plate;
whereby the probe is reciprocally slidable in the guide in liquid sample handler operations.

6. The combination of claim 5, further comprising a probe rinse cup, and means for moving the rinse cup wherein the rinse cup is disposed below the probe, whereby the probe slides through the guide hole into the rinse cup for rinsing the probe.

7. The combination of claim 6, further comprising means for mounting the rinse cup to the support head, and further comprising means for reciprocally moving the rinse cup for selectively positioning the rinse cup under the probe for rinsing the probe and away from the probe to clear the probe so that the probe is extended for aspirating or dispensing a sample.

8. The combination of claim 7, said probe having a first end for aspirating the sample, said probe having a second end, and dispensing means disposed at the second end of the probe for dispensing the sample.

9. The combination of claim 8, said dispensing means comprising a valve for dispensing a predetermined measured liquid sample through the second end, or back through the first end.

10. The combination of claim 9, said valve means comprising a multi-port injector valve.

11. The combination of claim 5, said guide comprising a one-piece plastic construction.

12. The combination of claim 5, said guide comprising a cylinder, said cylinder having an upper cylindrical body and a lower cylindrical body, said plate having an aperture, and said lower cylindrical body being disposed in said plate aperture.

13. The combination of claim 12, said guide comprising a one-piece plastic construction.

14. The combination of claim 13, further comprising a probe rinse cup, and means for moving the rinse cup, wherein the rinse cup is disposed below the guide through-hole, whereby the probe slides through the passageway into the rinse cup.

15. The combination of claim 14, further comprising means for mounting the rinse cup to the support head, and means for reciprocally moving the rinse cup for selective positioning under the guide through-hole.
